(19) United States
(12) Patent Application Publication
(10) Pub. No.: US 2026/0126029 A1
(43) Pub. Date: May 7, 2026

(54) Community Wind Turbine Cellular System

(71) Applicant: Malachite Communication Systems Incorporated, Fountain Hills, AZ (US)

(72) Inventor: David Jones, Fountain Hills, AZ (US)

(21) Appl. No.: 19/379,978

(22) Filed: Nov. 5, 2025

Related U.S. Application Data
(60) Provisional application No. 63/716,476, filed on Nov. 5, 2024.

(51) Int. Cl. F03D 80/80; H01Q 1/24

(52) U.S. Cl. CPC F03D 80/821; H01Q 1/246

(57) ABSTRACT

A community wind turbine cellular system (CWTC system) is disclosed. The CWTC system is configured to provide community-based cellular communication, on a temporary or permanent basis. One or more turbine blades of the CWTC system are configured with an omni-directional radio frequency (RF) antenna suitable for receiving and transmitting mobile communication data to cellular devices. These omni-directional RF antenna have an uninterrupted wired connection that passes from the antenna to an antenna radio within the system's nacelle. More particularly, each RF antenna in a turbine blade is connected, via a wired connection, to a corresponding slip ring within the nacelle of the cellular wind turbine. Each slip ring is connected to the antenna radio via a wired connection. In this manner, each RF antenna maintains a wired connection to the antenna radio, even as the turbine blades are rotating.

### RELATED APPLICATIONS

This application is related to U.S. Provisional Patent Application No. 63/716,476, entitled “Community Wind Turbine Cellular System,” filed Nov. 5, 2024, which is incorporated herein by reference. This application is also related to U.S. Provisional Patent Application No. 63/651,895, entitled “Wind Turbine Cellular Tower,” filed May 24, 2024, which is incorporated herein by reference. This application is further related to PCT Patent Application No. PCT/US25/30399, entitled “Wind Turbine Cellular Tower,” filed May 21, 2025, which is incorporated herein by reference.

### BACKGROUND OF THE INVENTION

Cellphone use is ubiquitous in today's society. According to recent surveys and projections, nearly 97% of all adults in the United States have and use a cellphone of some kind. However, in spite of the widespread adoption of cellphones, cellphone users also understand that cellphone service, i.e., the ability to connect to infrastructure that provides cellular intercommunications with others, including voice and data, is an issue. Densely populated areas are less likely to have cellphone service issues. However, rural and remote areas are often poorly served by cellphone service. Hilly and/or mountainous terrain can, and often do, result in cellphone service gaps for an otherwise well-served area. Further, power outages from weather-related events, from natural disasters, even rolling blackouts, will result in at least a temporary loss of cellphone service.

Another issue associated with cellphone service is that areas that have some cellphone service can be quickly overwhelmed when an occurrence arises that significantly increases the number of people and services requesting and utilizing the available cellphone services.

For cellular carriers, erecting cellphone towers in poorly served areas or eliminating coverages gaps is costly is, quite typically, un-profitable. Moreover, obtaining permits to erect a cellphone tower is a time-consuming, often vexing problem for the various cellphone carriers.

Ultimately, almost every cellphone user will, at some time, discover they are currently without cellphone coverage or service as a result of one or more of the above-identified weaknesses.

### SUMMARY OF THE INVENTION

A community wind turbine cellular system configured to provide cellular coverage in a variety of locations and circumstances, including community-based use, or to provide temporary cell or enhanced cellular coverage, is presented. At least one blade of the community wind turbine of a community wind turbine cellular system, and typically all blades of the community wind turbine, are configured with omni-directional radio frequency (RF) antenna suitable for receiving and transmitting mobile communication data to cellular phones. Each RF antenna has a wired connection that passes from the antenna, through the turbine blade, to a connection within the wind turbine's nacelle. More particularly, each RF antenna is connected, via a wired connection to a slip ring within the nacelle of the cellular wind turbine, configured such that there is one slip ring per RF antenna. Each slip ring is attached to an antenna radio via a wired connection. In this manner and due to the properties and mechanics of slip rings, each RF antenna maintains a wired connection to the antenna radio.

The antenna radio is also connected via wired (including optical lines) and/or wireless transmission infrastructure that connects users of the community wind turbine cellular system other cellular carriers or networks.

According to aspects of the disclosed subject matter, community wind turbine cellular systems advantageously provide coverage in areas where there is no meaningful cellular coverage. A community wind turbine cellular system provides coverage where high-band carrier-based cellphone coverage is insufficient for the needs of a community. A community wind turbine cellular system can provide coverage during power outages which may result from natural disasters, accidents, rolling blackouts, and the like.

Advantageously, a community wind turbine cellular system can be linked with one or more other community wind turbine cellular systems to provide cellphone coverage for multiple poorly serviced areas or communities, such that the intercommunication infrastructure and costs associated with connecting to cellular carriers and/or network can be shared. A community wind turbine cellular system is advantageous to a “green” energy effort: being a wind turbine, a community wind turbine cellular system can generate “renewable” power for its own operations, store power in associated battery panels, as well as generate power to be placed on the grid. A community wind turbine system can be temporarily installed and used when coverage becomes unavailable or insufficient.

Advantageously, a community wind turbine cellular system provides a number of community benefits. For example, the community wind turbine cellular system provides a “green,” localized and reliable cellular system with the ability to scale as needed, including temporary deployment of a community wind turbine cellular system. The community wind turbine cellular system can cover multiple, difficult-to-serve communities with green, reliable cellular service. The community wind turbine cellular system may be deployed, with supporting infrastructure, which enables continued cellular service for a predetermined or continuous period during power outages.

While community wind turbine cellular system may make cellular communication available to all cellular devices within communication reach, according to aspects of the disclosed subject matter, a suitably equipped community wind turbine cellular system may prioritize cellular communication for subscribed members or subscribing member classes. The subscribing member classes may include members of local, regional or even national government, first responders (including police, fire, rescue, EMTs, etc.), schools, colleges, universities, community services, enterprises (which may include differentiated service levels for members of the enterprise), and importantly, people of the served communities. As will be discussed below, a suitably configured community wind turbine cellular system may be providing each subscribing class with a corresponding level of service and/or priority.

Regarding the levels of service provided to various classes, and according to aspects of the disclosed subject matter, in various embodiments, the level of cellular services among subscribing classes and among community members may differ. For example, and by way of illustration, higher levels of cellular services may be offered to first responders, premium vs. basic member subscribing levels, governmental employees, and the like. As suggested by variance among subscribing members, each subscribing class may provide differentiated levels of service according to some predetermined prioritization. In short, the community wind turbine cellular system is an extremely flexible, scalable cellular system that can provide cellular service to un-served or under-served communities.

Regarding the community wind turbine cellular system's prioritization of classes, in accordance with various embodiments of the disclosed subject matter, a community wind turbine cellular system may provide enhanced and prioritized levels of cellular service to classes and prioritized members of those classes through the allocation of dedicated slices of within the utilized RF spectrum, also referred to as network slicing, to those classes and subscribers. For example and by way of illustration and not limitation, network slicing may be used to prioritize local, regional and/or national government cellular communications, first responder (e.g., law enforcement, fire, emergency services and/or rescue) cellphone communications, enterprise/corporate communications, subscription prioritization to individuals and/or groups of individuals, as well as schools and education organizations with potential prioritization to persons (teachers, administration, etc.) within those organizations. Such prioritization, of course, may be based on circumstances, e.g., during times of disaster and/or crisis, and can be highly configurable.

Further still, while the community wind turbine system has been illustrated as being deployed outside of any enclosure, many aspects of the disclosed subject matter may be applied to deployment with respect to a physical structure or structures. Indeed, in-building infrastructure (with a localized wind turbine on the top of the building or nearby) may be used for improved indoor cellular services. Additionally, the cellular users/subscribers of such “indoor” infrastructure may be limited to specific departments, groups or branches, or even down to individual users. Further, each group (class) can have different defined quality of service (QoS) and prioritization.

### BRIEF DESCRIPTION OF FIGURES

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating a community wind turbine cellular system formed in accordance with various aspects of the disclosed subject matter;

FIG. 2 is a pictorial diagram illustrating exemplary interconnecting community wind turbine cellular systems configured to provide extended service to multiple remote areas, all in accordance with aspects of the disclosed subject matter;

FIG. 3 is a pictorial diagram illustrating an exemplary nacelle of a community wind turbine cellular system, configured in accordance with aspects of disclosed subject matter; and

FIG. 4 is a pictorial diagram illustrating an alternatively configured wind turbine tower that includes the RF antennae of the wind turbine tower of FIG. 1, and further includes high-gain cellular antennae for providing higher performance with cellular devices in close proximity to the wind turbine tower, all in accordance with aspects of the disclosed subject matter.

### DETAILED DESCRIPTION

A community wind turbine cellular system is presented, where the community wind turbine cellular system is configured to provide cellular service for personal and/or community-based use, or provide enhanced cellular coverage in areas of high demand, both on a permanent or temporary basis. The community wind turbine cellular (CWTC) system includes a wind turbine that has at least one turbine blade within which is incorporated (or included) an omni-directional radio frequency (RF) antenna. The omni-directional antenna of the at least one turbine blade is continuously connected to an antenna radio within a suitably configured nacelle of the wind turbine, even during power generation (i.e., the turbine blades rotating around the nacelle due to wind power.) The omni-directional RF antenna is configured to send and receive cellular communications with one or more cellular devices within a certain proximity of the wind turbine over a range of RF spectrums, and particularly over the citizen band radio spectrum (CBRS), i.e., 3550 MHz to 3700 MHz.

In various embodiments of the disclosed subject matter, each of the turbine blades of a suitably configured wind turbine are configured to incorporate an omni-directional antenna (each of which is in continuous connection with the antenna radio in the nacelle) to provide enhanced signal receipt and transmission.

As indicated, each omni-directional RF antenna (“RF antenna” for short) has a wired connection that passes from the antenna through the host turbine blade to the turbine blade's connection with the wind turbine's nacelle. At the connection of a turbine blade to nacelle, each wired connection is attached to a corresponding slip ring, with one slip ring for each RF antenna. Each slip ring is attached to a wired connection to the antenna radio. As those skilled in the art will appreciate, the use of a slip ring enables continuous connection between the RF antennae and the antenna radio, even while the turbine blades are rotating around the nacelle under wind power (and, at the same time, while generating power.)

The CWTC system includes connecting infrastructure that permits the antenna radio to send and receive cellular communication data to remote established cellular networks. In various non-limiting embodiments, while the CWTC system is a community-based, localized system, typically independent of national carriers and/or networks, via the connecting infrastructure that typically, though not exclusively, includes at least one microwave antenna, the CWTC system transmits and receives cellular communication data with remote, established cellular networks, including interaction with one or more 5G cores of the external cellular carriers. Indeed, the CWTC system provides cellular communication between community members that are not served (or are underserved) by the established cellular networks, as well as communications between community members and others operating on those established cellular networks.

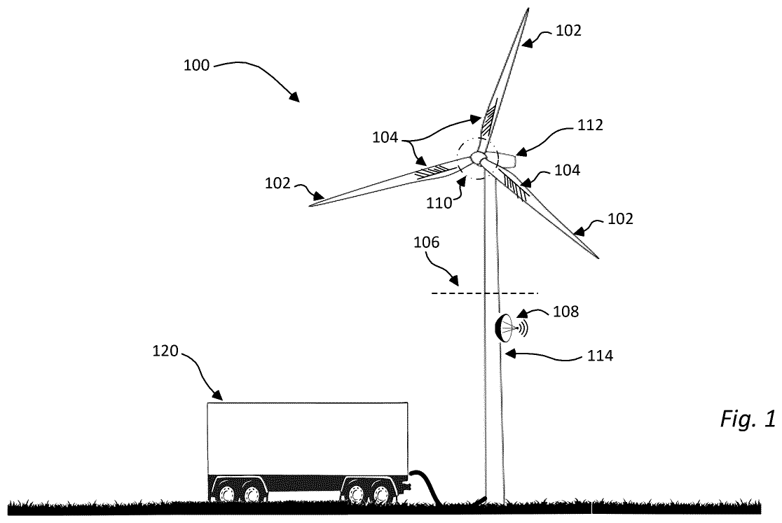

Turning to FIG. 1, this figure presents a pictorial diagram illustrating a community wind turbine cellular (CWTC) system 100, formed in accordance with various aspects of the disclosed subject matter. As illustrated, the CWTC system 100, the system includes typical elements of a wind turbine whose purpose is to generate power. These elements include a wind turbine tower 114 upon which rests a nacelle 112 connected to three turbine blades 102. Regarding the three turbine blades, it has been shown that having three turbine blades on a wind turbine is typically the most efficient configuration, especially on larger wind turbines intended for power generation. However, the disclosed subject matter is not restricted to a wind turbine configuration having three turbine blades. Indeed, in various embodiments of the disclosed subject matter, other configurations (including variances of the number of turbine blades) may be utilized. Considerations such as placement or location including lower wind speed areas, on top of or around building structures, or simply in community applications where the wind turbine must be smaller and/or mounted lower to the ground, may inform the alternative configuration of wind turbine/turbine blade configurations, all without departing from the disclosed subject matter.

As indicated above, one or more turbine blades 102 incorporate an omni-directional RF antenna 104 which can transmit and receive cellular communication data for the CWTC system 100. As illustrated in FIG. 1, each wind turbine blade 102 of the CWTC system 100 incorporates an omni-directional RF antenna 104.

The CWTC system may include optional power infrastructure 120 for providing operational power, at times of no or insufficient wind, to the CWTC system sufficient to maintain operation of the cellular communication function of the system. The power infrastructure 120 may comprise include power walls (large commercial batteries, such as Tesla's® Powerwall 3) to provide operational power for a predetermined amount of time. Thus, at times at which wind power is captured by the wind turbines 102, the generated energy can be used to charge or recharge the power infrastructure. In various embodiments, the power infrastructure 120 comprises 4 to 6 power walls suitable for sustaining the CWTC system in providing cellular service to members for up to a week or longer (dependent on whether and to what extent wind power is captured and stored.) Alternatively, not shown, the power infrastructure may comprise a power generator, such as a diesel generator. While leaving a higher carbon footprint, a diesel generator may be the ideal power source in locations that have been isolated by disaster, either to power the power infrastructure (batteries) or provide direct power to the CWTC system. In yet another embodiment, in many (if not most) remote communities, a power grid may be available to supply any power that the CWTC system 100 may require to provide and maintain cellular communications for community members.

Also illustrated with respect to the CWTC system 100 is that the omni-directional RF antennae 104 are integrated with the turbine blades 102 at a predetermined distance from the connection of the wind turbine blades to the nacelle 112. In various embodiments of the disclosed subject matter, and when larger wind turbines are used, the distance as indicated by circle 110, is between three and five meters from the nacelle. Of course, in various embodiments, the omni-directional RF antennae may be located anywhere along the turbine blades, preferably, though not limited to, the same distance for each RF antenna/turbine blade. It should be appreciated, however, that the further that the omni-directional RF antennae 104 are located from the nacelle 112, the more rapidly the RF antennae will be rotating under wind power, which high rotation rate may require additional processing support (e.g., by the antenna radio in conjunction with a communication processing computer) in order to provide reliable cellular communication with the cellular devices of community members and/or subscribers.

As will be appreciated, in many communities or regions where cellular service is poor, overtaxed and/or non-existent, there may not be any existing local infrastructure over which backhaul operations between the CWTC system 100 and external carrier networks. Of course, where such infrastructure is available, the CWTC system 100 would connect to those resources (not shown) to perform the backhaul of the exchange cellular communications with one or more external carrier networks and/or system. However, when there is no ready infrastructure to communicate with the external carriers, or their hubs, or network backbones, the CWTC system may include backhaul infrastructure, such as including one or more microwave antennae, such as microwave antenna 108, to transmit and receive cellular communication data to and from external cellular carriers. Moreover, to ensure that these backhaul services with external cellular carriers are carried out without interruption, the microwave antennae (or antenna 108) is mounted on the turbine tower 114 below the lowest extent of the wind turbine blades 102 as they rotate.

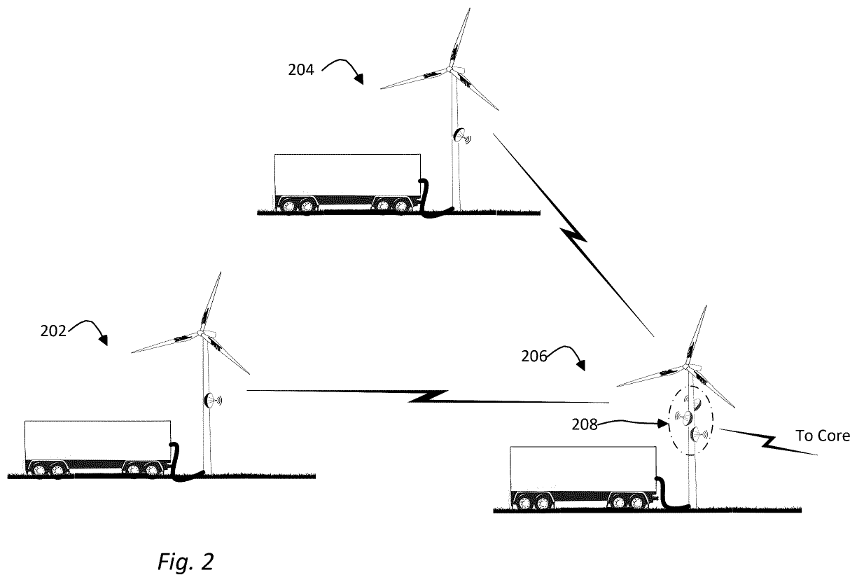

As mentioned above, multiple microwave antennae may be mounted on the turbine tower 114 of the CWTC system 102. Indeed, multiple CWTC systems can be interconnected, and a first CWTC system may connect to a second CWTC system, which in turn would relay information on (to another CWTC system or to a network core of a cellular carrier or network.) In various embodiments, the interconnected systems may be shared by the community members of the interconnected systems. To illustrate, reference is now made to FIG. 2.

FIG. 2 is a pictorial diagram illustrating a collection of exemplary interconnected community wind turbine cellular systems configured to provide cellular communication to community members, all in accordance with aspects of the disclosed subject matter. Illustratively, the collection includes CWTC systems 202-206 in a type of “hub and spoke” organization, with both CWTC systems 202 and 206 being the spokes from hub CWTC system 204. As the “hub” of the collection 200, CWTC system 204 includes three microwave antennae, denoted by ellipse 208, with a microwave antenna for each of the two “spoke” systems and a microwave antenna for communicating with the remote cellular networks.

With respect to a collection of CWTC systems, it should be appreciated that the configuration is not limited to a hub and spoke configuration, or a chain configuration, but can be implemented in any combination. Of course, care should be given to ensure that the concentration of cellular communication data does not overwhelm the CWTC system that communicates with the remote cellular networks. In some instances (not shown in FIG. 2), and according to various embodiments of the disclosed subject matter, a communication tower with microwave antennae may be implemented as the communication point (to and from external cellular carriers/networks) for a collection of CWTC systems. Further still, satellite transmission may be used in the place of microwave transmissions to carry out the exchange of cellular communication data between one or more CWTC systems and remote cellular networks. In the event that high speed communication lines (electrical and/or optical) are locally available, backhaul functionality may be carried out of the local high speed communication lines.

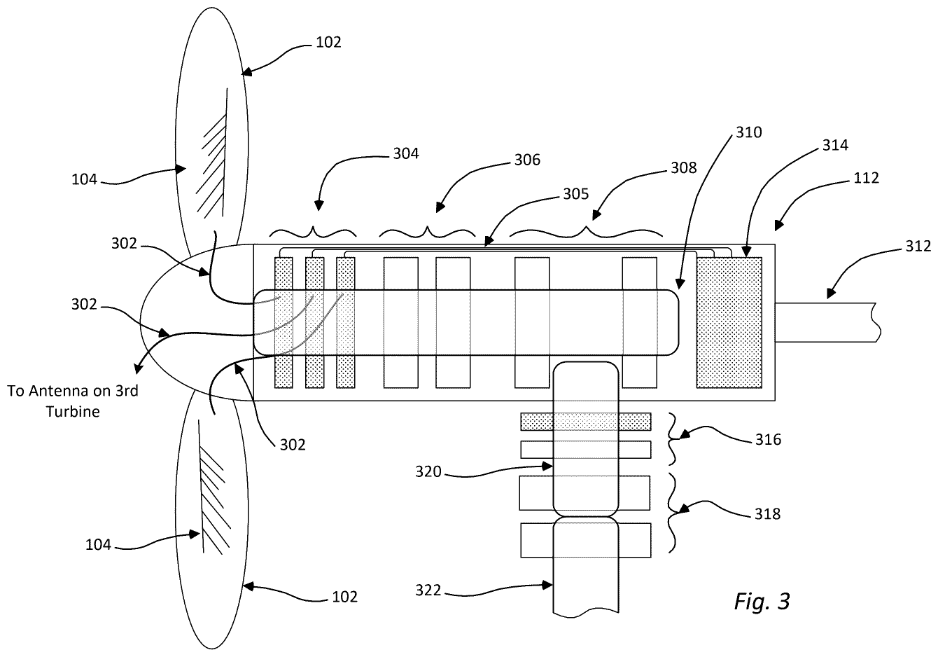

Turning now to FIG. 3, this figure is a pictorial diagram illustrating an exemplary nacelle 112 of a community wind turbine cellular system, such as CWTC system 100 described above, and configured in accordance with aspects of disclosed subject matter.

As those skilled in the art will appreciate, a typical configuration of a nacelle 112 will include, by way of illustration and not as an exhaustive list of elements, an alternator section 306 that includes rotating magnets and stationary coils. It is through the rotation of the main shaft 310 that power is generated. The typical nacelle further includes main bearings 308 that stabilize the main shaft as it rotates in response to wind causing the turbine blades to rotate.

Attached to the nacelle is a tail boom 312. As those skilled in the art will appreciate, the tail boom 312 assists the nacelle/turbine blades to maintain proper alignment with the source direction of the wind to generate power.

While not specifically part of the typical nacelle, nacelle 112 sits on top of a turbine tower 114 and rotates around slip rings 316 that enable the generated power to pass through the nacelle and down the tower, all the while being able to rotate in accordance with the direction of the incoming wind. Also included in this typical nacelle configuration are yaw bearings that stabilize the nacelle as wind turns the turbine blades, and as the nacelle rotates to face (with the turbine blades) the source direction of the wind. The nacelle is typically, though not exclusively, connected to the tower via a post 320, and stub mast 322, both of which are hollow or have a channel in which wired connections for, at least, generated electric and for cellular communication data, can pass. With the post affixed to the nacelle, and the stub mast affixed to the tower, bearings 318 permit the rotation of the two, relative to each other.

In accordance with aspects of the disclosed inventive subject matter, a nacelle suitably configured as part of a CWTC system, will include wired connections 302 which pass down each turbine from the turbine's omni-directional RF antennae 104 to a corresponding slip ring of a set of slip rings 304. In the same manner as the electrical connection remains constant for power delivery as the nacelle will rotate in accordance with the wind direction, and in conjunction with wired connections 305 from the slip rings to the antenna radio, the slip rings enable a constant connection between the omni-directional RF antenna and the antenna radio.

In addition to its connection to the slip rings 304, and because the nacelle can rotate, antennae radio 314 maintains a communication connection to the cellular network (either via microwave communications as described in relation to FIG. 1 or via wired connections are described in relation to FIG. 2) via one or more of the slip rings 316. As illustrated in FIG. 3, at least some slip rings 316 may be configured to communicate power (as generated by the turning of the turbine blades), and at least some may be configured to communicate cellular communications, enabling the backhaul of the cellular data.

According to aspects of the disclosed subject matter, the antenna radio 314 implements the services of a RAN (Remote Access Network) as it provides the bridge between members devices and a network core of one or more cellular carriers and/or cellular networks. Of course, as will be appreciated by those skilled in the art, in more general terms the antenna radio is the BBU (Baseband Unit) that processes cellular communication data between one or more cellular networks and members'cellular devices, enabling efficient data transmission.

According to various embodiments of the disclosed subject matter, the antenna radio 314 may incorporate a gNodeB (short for next Generation Node B), or alternative have a gNodeB associated component. As those skilled in the art will appreciate, the gNodeB is a crucial element of a RAN with supporting high bandwidth delivery and communications. A gNodeB is designed to interact with 5G cores and infrastructure, and incorporates architecture that supports, inter alia, enhanced mobile broadband, ultra-reliable low-latency communication, and the now-ubiquitous IoT (Internet of Things) deployments.

A network core handles a range of essential functions in the mobile network, such as connectivity and mobility management, authentication and authorization, subscriber data management and policy management. Often, 5G cores are software-based and implemented as cloud-based solutions. Due to the deployment of the 5G core in the cloud, the CWTC system's local infrastructure, particularly the antenna radio, will typically include only abilities sufficient infrastructure to manage users, maintains sufficient information for network slicing, carrier aggregation, maintain connections and related functionality in connection with and complimentary to the network core.

The antenna radio, in conjunction with an external/remote network core (typically though not exclusively implemented by a cellular carrier or cellular network, sorts and manages communications between cellphone users, including communications with members of external carriers and/or networks. Upon connecting by a member, the network radio obtains a profile for the member that enables the antenna radio to provide cellular coverage to cellphone users, including cellphone users connecting community members of the community wind turbine cellular system to users of the external carriers and networks.

According to aspects of the disclosed subject matter, while the CWTC system interacts with a network core, the CWTC system typically, though not exclusively, operates under a neutral host concept: i.e., the system is not a “node” of an established cellular carrier or cellular network. While the CWTC system is neutral, it still allows community members communication with devices of these other cellular carriers and cellular networks. A non-exclusive implementation has the CWTC system operating in the citizen band radio spectrum (CBRS), which is carrier independent. Of course, the disclosed community wind turbine may be configured to operate in other spectrum bands. However, in most instances, obtaining a license to operate in the CBRS band requires significantly less effort, and is typically much less expensive.

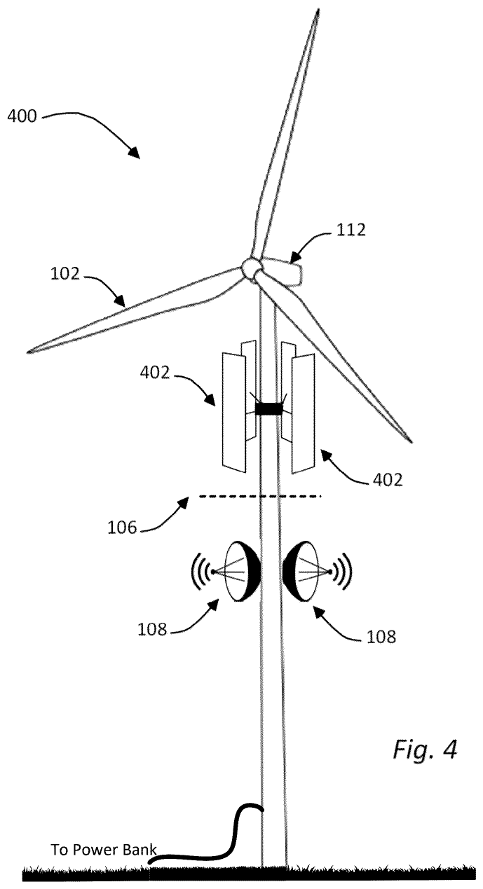

Turning now to FIG. 4, this figure is a pictorial diagram illustrating an alternatively configured wind turbine tower 400 that is configured to provide the above-described services of the CWTC system 100, and is further configured to include high-gain cellular antennae 402 for providing higher performance to members'cellular devices that are in close proximity to the wind turbine tower, all in accordance with aspects of the disclosed subject matter. Indeed, as an enhancement of the CWTC system, one or more high-gain directional antennae 402 may be mounted around the circumference the wind turbine tower 404. In various embodiments of the disclosed subject matter, the high-gain directional antennae are mid-band antennae, i.e., configured to operate in mid bands, 1 to 7 GHz. The mid-band antennae are mounted around the circumference of the wind turbine tower 404 in an equidistant manner. Having one or more sectored mid band antennas per 120-degree area, with a 2 to 3-meter separation between them, will provide higher gain than omni-directional antennae on blades for members. However, with higher propagation of the mid-band antennae, the actual coverage area will be less, not reaching as far as the lower bands, e.g., the CBRS.

In various embodiments of the disclosed subject matter, the mid-band antennae 402 may be mounted on the wind turbine tower below the nacelle 112 but above the lowest extent 106 of the wind turbine blades 102 as they rotate. This, of course, will mean that cellular devices that are otherwise within range of the CWTS system to use the mid-band antennae for higher performance may encounter interference due to the positioning of the turbine blades, (including and especially when the turbine blades are rotating under wind power.) In these instances, communication resorts to the lower band used by the omni-directional RF antennae 104 incorporated within the turbine blades 102.

Advantageously, the higher bands that are available for use by the mid-band antennae 402 could be used to implement carrier aggregation which would supplement the overall omni-directional coverage nearer the CWTC system 102 with better performance with higher bandwidth. As those skilled in the art will appreciate, carrier aggregation refers to techniques used to combine two or more non-contiguous spectrum bands into a single data channel, thereby enhancing throughput.

In addition to carrier aggregation, the CWTC system 100 may utilize a technique referred to as network slicing. Network slicing refers to the partitioning (all or a portion) the available spectrum, and dedicating partitions to supporting various service properties for specific “slice members.” For example, and by way of illustration and not limitation, network slicing may be used to provide a dedicated segment of the available spectrum to a member group of first responders. In other examples, network slicing may be used to provide a dedicated segment of the available spectrum to subscribers, i.e., parties willing to pay a subscription fee to have the dedicated segment available for their exclusive use. According to embodiments of the disclosed subject matter, the antenna radio working with a network core service, identifies a given member when connection is made to the CWTC system, obtains a profile that identifies information such as a group membership(s), and attempts to provide the corresponding level of service available to member's group membership(s). It follows, then, that services for such data/gaming services may be deprioritized. Also, depending on the user profile of a member, the CWTC system might allow roaming from the private network onto one or more of the public networks, such as when out of the local coverage area. Generally, though not exclusively, incoming roaming for carrier-based members would not be allowed in order to maintain the available resources for the subscribing, private members.

For cellular devices that are away from the CWTC system 192, the system will revert to utilizing the low band service, e.g., CBRS. As indicated above, in the event that rotating turbine blades create interference, the mid-band antennae will provide less consistent service and revert, when necessary, to the low band service. However, as members travel beyond the coverage area of the mid-band service, and/or as interference is encountered, cellular services will still be maintained, but at a lower bandwidth.

While CWTC system has been largely illustrated as including a wind turbine using three turbine blades, which is a highly optimal solution for generating electricity from wind power, it should be appreciated this configuration is illustrative and not limiting upon the disclosed subject matter. Indeed, the disclosed invention may be implemented on wind turbine towers that have two or more turbine blades. Indeed, a common alternative to three turbine blades include wind turbine towers that utilize four or five turbine blades. In such embodiments, a cellular antenna may be incorporated into all or some of the turbine blades. Further still, alternatively configured wind turbines do not use the “propeller” turbine blades of FIGS. 1 and 4, but these alternative configurations are also covered by the disclosed subject matter. Alternative wind turbine configurations suitable to be configured to operate as an CWTC system include wind turbines utilize spiral blades, paddles, and the like, all of which are designed as elements to capture wind for power generation, and all of which can be configured to incorporate an omni-directional cellular antenna (or antennae) and operate as a community wind turbine cellular system.

While much of the disclosure has been made with positioning a suitably configured CWTC system in an outdoor location to serve a communication, in various embodiments of the disclosed subject matter, a CWTC system may be deployed as an in-building feature, providing cellular service in an indoor space. In all cases and as described above, the community members that have access through the CWTC system can be limited in any number of ways and levels, which may include (illustratively and not by way of limitation) enhanced service to specific members of departments, groups or branches, or subscribing users. Also, each group can be configured to have service according to an associated quality of service (QoS) and prioritization. As an example, and without limitation, in an education facility, a member group comprising teachers and administrators could be given priority service over a member group comprising students, though each group is communicating through the same CWTC system.

1. A community wind turbine cellular system comprising, at least:
a wind turbine suitably configured to generate electricity by wind power, and further configured to provide cellular communication services to cellular devices of community members, wherein the wind turbine comprises at least:
a plurality of turbine blades which rotate around a center axis of a nacelle of the wind turbine under wind power thereby generating electricity, wherein at least a first turbine blade of the plurality of turbine blades incorporates an omni-directional radio frequency (RF) antenna suitable for sending and receiving cellular communications with cellular devices of community members in reception range of the wind turbine;
an antenna radio within the nacelle having an electrical connection to the omni-directional RF antenna of the at least first turbine, and configured to send and receive cellular communication data via the omni-directional RF antenna of the at least first turbine blade to provide cellular communication to the community members.

2. The community wind turbine cellular system of claim 1, wherein the antenna radio is configured to send and receive cellular communication data via the omni-directional RF antenna within the citizen band radio spectrum (CBRS).

3. The community wind turbine cellular system of claim 1, wherein the radio antenna is configured to operate as a neutral host.

4. The community wind turbine cellular system of claim 1, wherein the radio antenna is configured to send and receive cellular communication data with a remote network core of a cellular provider, enabling communication between cellular devices of community members and cellular devices outside of communication range of the community wind turbine cellular system.

5. The community wind turbine cellular system of claim 4, further comprising:
a first microwave antenna mounted on the wind turbine below a lowest extent of the plurality of wind turbine blades;
wherein the antenna radio has a communication connection with the first microwave antenna, and wherein the antenna radio sends and receives cellular communication data with the remote network core of a cellular provider via the first microwave antenna.

6. The community wind turbine cellular system of claim 4, further comprising:
a second microwave antenna mounted on the wind turbine below a lowest extent of the plurality of wind turbine blades;
wherein the antenna radio has a communication connection with the second microwave antenna, and wherein the antenna radio sends and receives cellular communication data from a second community wind turbine cellular system; and
wherein the antenna radio relays cellular communication data from a second community wind turbine cellular system not directed to the community members to the remote network core of the cellular provider via the first microwave antenna.

7. The community wind turbine cellular system of claim 4, wherein the remote network core is a 5G network core.

8. The community wind turbine cellular system of claim 7, wherein the radio antenna is configured to include at least a portion of a gNodeB infrastructure to facilitate cellular communication with the 5G network core.

9. The community wind turbine cellular system of claim 1, wherein:
each turbine blade of the plurality of turbine blades includes an omni-directional RF antenna;
the antenna radio has an electrical connection for each omni-directional RF antenna of each turbine blade of the plurality of turbine blades; and
the antenna radio is configured to send and receive cellular communication data via any of the plurality of omni-directional RF antennae to provide cellular communication to the community members.

10. The community wind turbine cellular system of claim 9, wherein each electrical connection of the radio antenna to an omni-directional RF antenna includes a slip ring within the nacelle that maintains continuous connectivity of the electrical connection of the radio antenna to a corresponding omni-directional RF antenna, irrespective of whether the plurality of turbine blades are rotating around the center axis of the nacelle.

11. The community wind turbine cellular system of claim 9, wherein the omni-directional RF antennae are located within a corresponding turbine blade at least three meters from the turbine blade's connection with the nacelle.

12. The community wind turbine cellular system of claim 1, further comprising:
a plurality of mid-band RF antennae mounted equidistantly around the circumference of the wind turbine above a lowest extent of the turbine blades; and
wherein the antenna radio has an electrical connection for each mid-band antenna to send and receive cellular communication data via any of the plurality of mid-band antennae.

13. The community wind turbine cellular system of claim 1, wherein the community wind turbine system employs carrier aggregation to provide enhanced cellular service performance for community members.

14. The community wind turbine cellular system of claim 1, wherein the community wind turbine system employs network slicing of an RF spectrum in use by the community wind turbine cellular system, such that cellular communications corresponding to a first group of community members is transmitted in a first network slice of the RF spectrum, and cellular communications corresponding to a second group of community members is transmitted in a second network slice of the RF spectrum.

15. The community wind turbine cellular system of claim 14, wherein the RF spectrum is the citizen band radio spectrum.

16. A multi-community wind turbine cellular system, comprising:
a first community wind turbine cellular system providing cellular service to members of a first community, wherein the first community wind turbine cellular system operates as a neutral host in providing cellular communication services to the members of the first community, and is configured to send and receive cellular communication data with a network core of a cellular provider or a cellular network; and
a second community wind turbine cellular system providing cellular services to members of a second community, wherein:
the second community wind turbine cellular system operates as neutral host in providing cellular communication services to members of the second community;
at least some members of the second community are outside of cellular communication range with the first community wind turbine cellular system; and
the second community wind turbine cellular system is configured to send and receive cellular communication with the network code of the cellular provider via communication with the first community wind turbine cellular system.

17. The multi-community wind turbine cellular system of claim 16, wherein the first community wind turbine cellular system is configured to send and receive cellular communication data with the network core via microwave transmissions.

18. The multi-community wind turbine cellular system of claim 1, wherein the first community wind turbine cellular system comprises a first microwave antenna mounted on a wind turbine tower of the first community wind turbine cellular system to communicate cellular communication data with the network core, and a second microwave antenna mounted on the wind turbine tower of the first community wind turbine cellular system to communicate cellular communication data with the second community wind turbine cellular system.

19. The multi-community wind turbine cellular system of claim 18, wherein the second community wind turbine cellular system comprises a third microwave antenna mounted on a wind turbine tower of the second community wind turbine cellular system to communicate cellular communication data with the network core via microwave transmissions between the third microwave antenna of the second community wind turbine cellular system and the second microwave of the first community wind turbine cellular system.
